(19) United States
(12) Patent Application Publication
(10) Pub. No.: US 2026/0257936 A1
(43) Pub. Date: Sep. 3, 2026

(54) POSITIVE ELECTRODE ACTIVE MATERIAL, LITHIUM ION SECONDARY BATTERY AND METHOD FOR MANUFACTURING POSITIVE ELECTRODE ACTIVE MATERIAL

(71) Applicant: HONDA MOTOR CO., LTD., Tokyo (JP)

(72) Inventors: Takashi HAKARI, Saitama (JP); Ikuno MEGURO, Saitama (JP)

(21) Appl. No.: 19/549,159

(22) Filed: Feb. 25, 2026

(30) Foreign Application Priority Data
Feb. 28, 2025 (JP) 2025-031260

(51) Int. Cl. C01G 49/10

(52) U.S. Cl. CPC C01G 49/10; C01P 2002/72; C01P 2006/40

(57) ABSTRACT

A positive electrode active material including a lithium-iron composite fluoride as a principal component,
the lithium-iron composite fluoride being represented by the following formula (1),

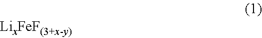

where, x and y are numbers satisfying 0.4<x<1.2 and 0.01<y<0.5.

### BACKGROUND

### Technical Field

The present invention relates to a positive electrode active material, a lithium ion secondary battery, and a method for manufacturing a positive electrode active material.

### Related Art

In recent years, research and development on secondary batteries that contribute to energy efficiency are conducted so that more people are able to access affordable, reliable, sustainable, and advanced energy. In particular, lithium ion secondary batteries are becoming increasingly important as power sources for electric vehicles (EV), hybrid electric vehicles (HEV), and the like.

A positive electrode active material has attracted attention as an important component for determining the capacity of a lithium ion secondary battery, and development thereof has been advanced. As a positive electrode active material used for a lithium ion secondary battery, for example, iron (Fe)-based lithium iron phosphate (LiFePO₄) with low resource risk is known. LiFePO₄ is excellent in cycle characteristics and safety, but has a low voltage and a small capacity. Therefore, the energy density (voltage×capacity) represented by the product of voltage and capacity is small as compared with a conventionally used material based on nickel (Ni) or cobalt (Co). In order to construct a small battery, an electrode material with a high energy density is required, and in order to realize the high energy density, a high-voltage operation of a battery is important.

For the purpose of increasing the voltage of a battery using a material including an element with low resource risk, use of a high-valent transition metal (for example, not Fe²⁺⇔Fe³⁺ but Fe³⁺⇔Fe⁴⁺) is expected. However, Fe⁴⁺ is very unstable and becomes Fe³⁺ by side reaction, or Fe⁴⁺ requires a very large amount of energy and is not generated in some cases. Thus, even though an Fe³⁺ compound is used as the positive electrode active material, it is not necessarily capable of operating at a high voltage.

For example, it has been reported in F. Badway, et al., “Carbon Metal Fluoride Nanocomposites” J. Electrochem. Soc., 150(10) A1318-A1327 (2003) that LiFeF₃ is generated during charge and discharge by using ferric fluoride (FeF₃), and the average discharge voltage is 3.1 V. It has been reported in Y. Hu, et al., “A Simple, Quick and Eco-Friendly Strategy of Synthesis Nanosized α-LiFeO₂ Cathode with Excellent Electrochemical Performance for Lithium-Ion Batteries” Materials, 11, 1176 (2018) that LiFeO₂ can be expected to have a high energy density.

### CITATION LIST

### Non Patent Literatures

Non Patent Literature 1: F. Badway, et al., “Carbon Metal Fluoride Nanocomposites” J. Electrochem. Soc., 150(10) A1318-A1327 (2003)
Non Patent Literature 2: Y. Hu, et al., “A Simple, Quick and Eco-Friendly Strategy of Synthesis Nanosized α-LiFeO₂ Cathode with Excellent Electrochemical Performance for Lithium-Ion Batteries” Materials, 11, 1176 (2018)

### SUMMARY

In Y. Hu, et al., “A Simple, Quick and Eco-Friendly Strategy of Synthesis Nanosized α-LiFeO₂ Cathode with Excellent Electrochemical Performance for Lithium-Ion Batteries” Materials, 11, 1176 (2018), the actual voltage is about 2.5 V, which is lower than the expected voltage. The average discharge voltage (3.1 V) described in F. Badway, et al., “Carbon Metal Fluoride Nanocomposites” J. Electrochem. Soc., 150(10) A1318-A1327 (2003) is also lower than the voltage of LifePO₄, and there is room for improvement in order to further increase the voltage.

In addition, the Fe-based positive electrode active material has an insufficient capacity during discharge.

The present invention has been made to solve the above problems, and an object thereof is to provide an Fe-based positive electrode active material that can operate at a high voltage and can be increased in capacity during discharge, and a lithium ion secondary battery including the positive electrode active material. Furthermore, an additional object thereof is to reduce resource risk and contribute to cost reduction.

In order to achieve the above object, the present invention provides the following configurations.

[1] A positive electrode active material including a lithium-iron composite fluoride as a principal component,
the lithium-iron composite fluoride being represented by the following formula (1),

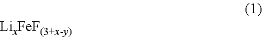

where, x and y are numbers satisfying 0.4<x<1.2 and 0.01<y<0.5.

It is considered that the positive electrode active material according to [1] can reduce the repulsion between the ferric ion (Fe³⁺) and the lithium ion (Li⁺) and is improved in ion conductivity, as compared with conventional lithium-iron composite fluorides. Therefore, the positive electrode active material has a high average discharge voltage, is capable of operating at a high voltage, and can be increased in capacity during discharge. As a result, in a lithium ion secondary battery including the positive electrode active material, the number of batteries required can be reduced, thereby contributing to cost reduction.

[2] The positive electrode active material according to [1], wherein, in the formula (1), x and y are numbers satisfying:

$$0.4 < x \leq 0.5 , and 0.01 < y < 0.1 or 0.2 < y < 0.5 ;$$

$$0.5 < x \leq 0.7 , and 0.01 < y < 0.5 ;$$

$$0.7 < x < 1. , and 0.01 < y < 0.1 or 0.1 < y < 0.4 ; or$$

$$1. \leq x < 1.2 , and 0.05 < y < 0.2 .$$

The positive electrode active material according to [2] can be further increased in capacity during discharge. Therefore, it is possible to increase the capacity of a lithium ion secondary battery containing the positive electrode active material, and further increase the energy density.

[3] The positive electrode active material according to [1] or [2], having a peak in a range of 20°≤2θ≤30° in an X-ray diffraction pattern.

The positive electrode active material according to [3] has a peak derived from the crystal structure of LiFe₂F₆. Therefore, the positive electrode active material has a high average discharge voltage and can operate at a high voltage.

[4] A lithium ion secondary battery including: a positive electrode; a negative electrode; and an electrolyte, wherein the positive electrode contains the positive electrode active material according to any one of [1] to [3].

In the lithium ion secondary battery according to [4], the positive electrode contains the positive electrode active material according to any one of [1] to [3]. This indicates that the battery can operate at a high voltage, and the capacity during discharge can be further increased.

[5] The lithium ion secondary battery according to [4], wherein a dQ/dV plot during discharge in a charge-discharge cycle has a peak in a range of 3.9 to 4.0 V.

This indicates that, in the lithium ion secondary battery according to [5], the positive electrode active material undergoes a chemical reaction in a high voltage range of 3.9 to 4.0 V. This indicates that the battery can operate at a higher voltage.

[6] The lithium ion secondary battery according to [4] or [5], having an average discharge voltage of 3.8 to 4.0 V.

The lithium ion secondary battery according to [6] has an average discharge voltage as high as 3.8 to 4.0 V. This indicates that the battery can operate at a high voltage.

[7] A method for manufacturing a positive electrode active material containing a lithium-iron composite fluoride as a principal component, the method including: using lithium fluoride, ferrous fluoride, and ferric fluoride as raw materials,
wherein the lithium-iron composite fluoride is represented by the following formula (1),

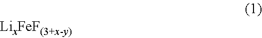

where, x and y are numbers satisfying:

$$0.4 < x \leq 0.5 , and 0.01 < y < 0.1 or 0.2 < y < 0.5 ;$$

$$0.5 < x \leq 0.7 , and 0.01 < y < 0.5 ;$$

$$0.7 < x < 1. , and 0.01 < y < 0.1 or 0.1 < y < 0.4 ; or$$

$$1. \leq x < 1.2 , and 0.05 < y < 0.2 .$$

The method for manufacturing the positive electrode active material according to [7] can provide a positive electrode active material having a high average discharge voltage and capable of operating at a high voltage. Therefore, in a lithium ion secondary battery containing the positive electrode active material, the number of batteries required can be reduced, thereby contributing to cost reduction.

[8] The method for manufacturing a positive electrode active material according to [7], wherein y in the formula (1) is changed depending on a blending amount of the ferrous fluoride.

The method for manufacturing the positive electrode active material according to [8] can provide a positive electrode active material having a high average discharge voltage and capable of operating at a high voltage. Therefore, in a lithium ion secondary battery containing the positive electrode active material, the number of batteries required can be reduced, thereby contributing to cost reduction.

According to the present invention, it is possible to provide an Fe-based positive electrode active material that can operate at a high voltage and can be increased in capacity during discharge, and a lithium ion secondary battery including the positive electrode active material.

### BRIEF DESCRIPTION OF DRAWINGS

FIG. 1 is a diagram illustrating a part of an X-ray diffraction pattern of a positive electrode active material according to an embodiment of the present invention;

FIG. 2 is a diagram illustrating a part of an X-ray diffraction pattern of a positive electrode active material in which x is x=0.4 and y is 0≤y≤0.4 in the formula (1);

FIG. 3 is a cross-sectional view schematically illustrating a lithium ion secondary battery according to an embodiment of the present invention;

FIG. 4 is a graph illustrating a discharge curve of a lithium ion secondary battery containing a positive electrode active material in which x is x=0.6 and y is 0≤y≤0.4 in the formula (1);

FIG. 5 is a graph illustrating a dQ/dV plot in a charge-discharge cycle of a lithium ion secondary battery containing a positive electrode active material in which x is x=0.6 and y is 0≤y≤0.4 in the formula (1);

FIG. 6 is a flowchart showing an example of a method for manufacturing a positive electrode active material according to an embodiment of the present invention;

FIG. 7 is a diagram illustrating a part of an X-ray diffraction pattern of a positive electrode active material in which x is x=0.5 and y is 0≤y≤0.4 in the formula (1);

FIG. 8 is a diagram illustrating a part of an X-ray diffraction pattern of a positive electrode active material in which x is x=0.8 and y is 0≤y≤0.4 in the formula (1);

FIG. 9 is a diagram illustrating a part of an X-ray diffraction pattern of a positive electrode active material in which x is x=1.0 and y is 0≤y≤0.4 in the formula (1);

FIG. 10 is a diagram illustrating a part of an X-ray diffraction pattern of a positive electrode active material in which x is x=1.2 and y is 0≤y≤0.4 in the formula (1);

FIG. 11 is a graph illustrating a charge-discharge curve of a lithium ion secondary battery containing a positive electrode active material in which x is x=0.4 and y is 0≤y≤0.4 in the formula (1);

FIG. 12 is a graph illustrating a charge-discharge curve of a lithium ion secondary battery containing a positive electrode active material in which x is x=0.5 and y is 0≤y<0.4 in the formula (1);

FIG. 13 is a graph illustrating a charge-discharge curve of a lithium ion secondary battery containing a positive electrode active material in which x is x=0.8 and y is 0≤y≤0.4 in the formula (1);

FIG. 14 is a graph illustrating a charge-discharge curve of a lithium ion secondary battery containing a positive electrode active material in which x is x=1.0 and y is 0≤y≤0.4 in the formula (1);

FIG. 15 is a graph illustrating a charge-discharge curve of a lithium ion secondary battery containing a positive electrode active material in which x is x=1.2 and y is 0≤y≤0.4 in the formula (1);

FIG. 16 is a graph illustrating a dQ/dV plot in a charge-discharge cycle of a lithium ion secondary battery containing a positive electrode active material in which x is x=0.4 and y is 0≤y≤0.4 in the formula (1);

FIG. 17 is a graph illustrating a dQ/dV plot in a charge-discharge cycle of a lithium ion secondary battery containing a positive electrode active material in which x is x=0.5 and y is 0≤y≤0.4 in the formula (1);

FIG. 18 is a graph illustrating a dQ/dV plot in a charge-discharge cycle of a lithium ion secondary battery containing a positive electrode active material in which x is x=0.8 and y is 0≤y≤0.4 in the formula (1);

FIG. 19 is a graph illustrating a dQ/dV plot in a charge-discharge cycle of a lithium ion secondary battery containing a positive electrode active material in which x is x=1.0 and y is 0≤y≤0.4 in the formula (1); and

FIG. 20 is a graph illustrating a dQ/dV plot in a charge-discharge cycle of a lithium ion secondary battery containing a positive electrode active material in which x is x=1.2 and y is 0≤y≤0.4 in the formula (1).

### DETAILED DESCRIPTION

Hereinafter, preferred embodiments of the present invention will be described in detail.

### [Positive Electrode Active Material]

The positive electrode active material of the present embodiment contains a lithium-iron composite fluoride as a principal component, and is used in a positive electrode of a lithium ion secondary battery. The phrase “contains a lithium-iron composite fluoride as a principal component” means that the content of the lithium-iron composite fluoride is 75% by mass or more, preferably 80% by mass or more, more preferably 90% by mass or more, and still more preferably 99% by mass or more with respect to the total mass of the positive electrode active material, and may be 100% by mass. The positive electrode active material may contain a component other than the principal component as long as the function of the present invention is not impaired.

The positive electrode active material of the present embodiment may include only one kind or two or more kinds of lithium-iron composite fluorides as long as the lithium-iron composite fluoride is included as a principal component.

In a case where the positive electrode active material is manufactured by using the lithium-iron composite fluoride as a principal component, the total composition ratio (Li:Fe:F) of the lithium-iron composite fluoride is also maintained in the obtained positive electrode active material. In a case where the positive electrode active material obtained by using the lithium-iron composite fluoride having such a composition as a principal component is used in a secondary battery, a high-voltage operation and an increased capacity can be achieved. In addition, the composition ratio of the lithium-iron composite fluoride is adjusted to be similar to a composition ratio required for a positive electrode active material to be obtained.

### (Lithium-Iron Composite Fluoride)

The lithium-iron composite fluoride of the present embodiment is represented by the following formula (1),

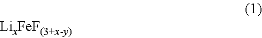

where, x and y are numbers satisfying 0.4<x<1.2 and 0.01<y<0.5. When x and y are within the above numerical range, a small battery having an increased average discharge voltage, an increased capacity, and a high energy density can be constructed.

In the formula (1), x and y are preferably numbers satisfying:

$$0.4 < x \leq 0.5 , and 0.01 < y < 0.1 or 0.2 < y < 0.5 ;$$

$$0.5 < x \leq 0.7 , and 0.01 < y < 0.5 ;$$

$$0.7 < x < 1. , and 0.01 < y < 0.1 or 0.1 < y < 0.4 ;$$

or
1.0≤x<1.2, and 0.05<y<0.2. When x and y are within the above numerical range, the average discharge voltage and the capacity can be increased. Therefore, it is possible to increase the capacity of a lithium ion secondary battery containing the positive electrode active material, and further increase the energy density.

In the formula (1), x represents the molar ratio between Li and Fe. The molar ratio between Li and Fe is x:1.

In the formula (1), y represents the number of moles of the fluoride ion (F⁻) derived from the ferrous ion (Fe²⁺). The molar ratio among Li, Fe, and F is x:1:(3+x-y).

The composition of the lithium-iron composite fluoride can be determined by inductively coupled plasma (ICP) emission spectrometry, combustion ion chromatography, or the like.

### <X-Ray Diffraction (XRD) Pattern>

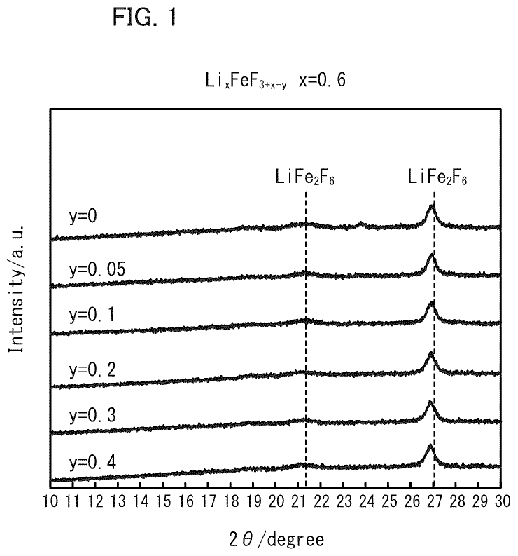

FIG. 1 illustrates, as an example of an X-ray diffraction (XRD) pattern of the positive electrode active material according to the embodiment, a part of XRD patterns where x is x=0.6 and y is 0≤y≤0.4 in the formula (1) (Examples 4 to 8 and Comparative Example 10 described later). As illustrated in FIG. 1, the positive electrode active material in which x is x=0.6 and y is 0≤y≤0.4 in the formula (1) has a peak in a range of 20°≤2θ≤30°. The peak around 2θ=27° represents a peak derived from the crystal structure of Life₂F₆. This means that the positive electrode active material in which x is x=0.6 and y is 0≤y≤0.4 in the formula (1) has the same crystal structure as that of Life₂F₆.

In addition, it is considered that the positive electrode active material in which x is x=0.6 and y is 0≤y≤0.4 in the formula (1) has excellent water resistance, is hardly attached with moisture, and has a stable crystal structure. As described above, the positive electrode active material according to the embodiment preferably contains no moisture.

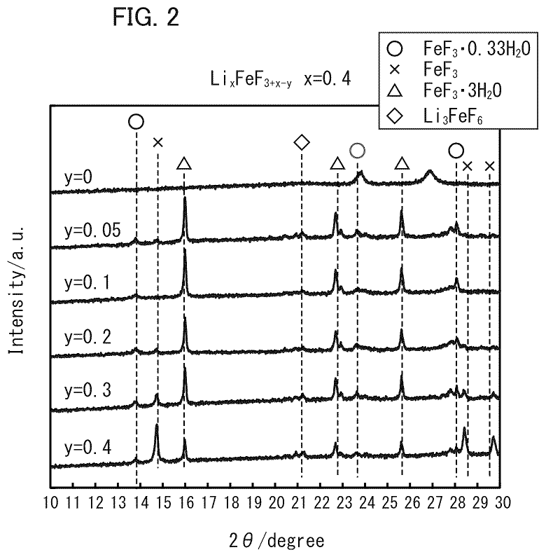

Next, FIG. 2 illustrates a part of XRD patterns where x is x=0.4 and y is 0≤y≤0.4 in the formula (1) (Comparative Examples 1 to 6 described later). As illustrated in FIG. 2, the positive electrode active material in which x is x=0.4 and y is 0≤y≤0.4 in the formula (1) has a plurality of peaks in a range of 20°≤2θ≤30°. The small peak around 2θ=21° represents a peak derived from the crystal structure of Li₃FeF₆. The peak in a range of 22°≤2θ≤23° and the peak in a range of 25°≤2θ≤26° represent peaks derived from the crystal structure of FeF₃·3H₂O. The peak in a range of 23°≤2θ≤24° and the peak around 2θ=28° represent peaks derived from the crystal structure of FeF₃·0.33H₂O. The peak in a range of 28°≤2θ≤29° and the peak in a range of 29°<2θ≤30° represent peaks derived from the crystal structure of FeF₃. As described above, it is considered that the positive electrode active material in which x is x=0.4 and y is 0≤y≤0.4 in the formula (1), having peaks derived from various crystal structures, has its crystal structure changed in the atmosphere. This is presumably because the positive electrode active material in which x is x=0.4 and y is 0≤y≤0.4 in the formula (1) has poor water resistance, and is easily attached with moisture.

### [Lithium Ion Secondary Battery]

The lithium ion secondary battery of the embodiment includes a positive electrode, a negative electrode, and an electrolyte, and the positive electrode contains the positive electrode active material containing the above-described lithium-iron composite fluoride as a principal component. The lithium ion secondary battery of the embodiment may include other battery elements as necessary.

The lithium ion secondary battery of the embodiment can employ battery elements of known lithium ion secondary batteries as they are except that the positive electrode contains the positive electrode active material containing the above-described lithium-iron composite fluoride as a principal component. The lithium ion secondary battery of the embodiment may have any of a coin type, a button type, a cylindrical type, a square type, and a laminate type. In addition, the lithium ion secondary battery of the embodiment is applicable to a wide range of applications such as mobile devices including mobile phones and laptop computers, and in-vehicle applications.

Hereinafter, as for the lithium ion secondary battery of the embodiment, a lithium ion secondary battery (coin-type lithium ion secondary battery) using an electrolytic solution will be described. Each battery element described below can be similarly applied to an all-solid-state lithium ion secondary battery using no electrolytic solution and a semi-solid lithium ion secondary battery.

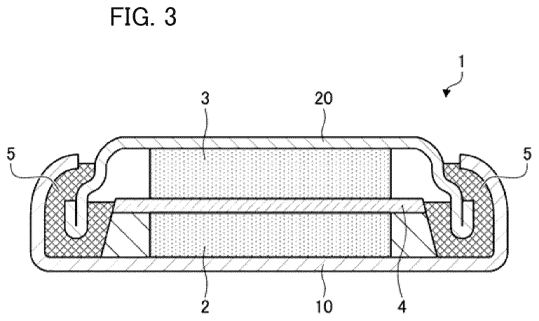

As illustrated in FIG. 3, a lithium ion secondary battery 1 of the embodiment includes a negative electrode can (negative electrode terminal) 20, a negative electrode 3, a separator 4 impregnated with an electrolytic solution, an insulating packing (gasket) 5, a positive electrode 2, and a positive electrode can 10.

The positive electrode can 10 is disposed below the separator 4, the negative electrode can 20 is disposed above the separator 4, and the outer shape of the lithium ion secondary battery 1 is formed by the positive electrode can 10 and the negative electrode can 20. The positive electrode 2 and the negative electrode 3 are disposed between the positive electrode can 10 and the negative electrode can 20 with the separator 4 impregnated with an electrolytic solution interposed therebetween, and the positive electrode 2 and the negative electrode 3 are separated from each other by the separator 4. The positive electrode can 10 and the negative electrode can 20 are electrically insulated from each other by the insulating packing 5.

In the lithium ion secondary battery 1, a positive electrode mixture is prepared by blending a conductive agent, a binder, and the like with the positive electrode active material of the embodiment as necessary, and the positive electrode 2 can be produced by pressing the positive electrode mixture to a current collector (not illustrated).

As the current collector, a stainless steel mesh, an aluminum foil, or the like can be preferably used. As the conductive agent, a carbon nanotube (CNT), acetylene black, Ketjenblack, or the like can be preferably used. As the binder, tetrafluoroethylene, polyvinylidene fluoride, or the like can be preferably used.

Blending of the positive electrode active material, the conductive agent, and the binder in the positive electrode mixture is not particularly limited. The content of the positive electrode active material in the positive electrode mixture is preferably 75% to 100% by mass, and more preferably 90% to 99% by mass. The content of the conductive agent in the positive electrode mixture is preferably 0.1% to 15% by mass, and more preferably 0.1% to 5% by mass. The content of the binder in the positive electrode mixture is preferably 0.1% to 10% by mass, and more preferably 0.1% to 5% by mass.

In the lithium ion secondary battery 1, as the negative electrode 3 with respect to the positive electrode 2, a known electrode, for example, a metal-based material such as metallic lithium and a lithium alloy, a carbon-based material such as graphite and mesocarbon microbeads (MCMB), and a silicon-based material such as silicon (Si), a Si alloy, and silicon oxide, which functions as a negative electrode active material and is capable of intercalating and deintercalating lithium, can be employed. Among these, metallic lithium and graphite are preferable as the negative electrode 3.

Known battery elements can be employed as the separator 4 and a battery container (positive electrode can 10 and negative electrode can 20).

As the electrolyte, a known electrolytic solution, a known semi-solid electrolyte, a known solid electrolyte, or the like can be employed. As the electrolytic solution, for example, a solution obtained by dissolving an electrolyte such as lithium perchlorate or lithium hexafluorophosphate in a solvent such as ethylene carbonate (EC), dimethyl carbonate (DMC), propylene carbonate (PC), or diethyl carbonate (DEC) can be used.

As the semi-solid electrolyte and the solid electrolyte, a known semi-solid electrolyte and a known solid electrolyte can be used except that the positive electrode active material containing the above-described lithium-iron composite fluoride as a principal component is used.

Examples of the semi-solid electrolyte include an electrolyte containing a polymer component and a standard electrolytic solution. Examples of the polymer component include polyvinylidene fluoride (PVDF)/polyethylene oxide (PEO), polyacrylonitrile (PAN)/PEO, polymethyl methacrylate (PMMA), and PVDF/hexafluoropropylene (HFP). Examples of the standard electrolytic solution include a solution of 1 mol/L lithium hexafluorophosphate (LiPF₆) in EC/DMC, a solution of 1 mol/L LiPF₆ in EC/ethyl methyl carbonate (EMC), and a solution of 1 mol/L LiPF₆ in EC/DMC/EMC.

As for the all-solid-state lithium ion secondary battery, as the electrolyte, for example, solid electrolytes such as a polymer-based solid electrolyte such as a polyethylene oxide-based polymer compound and a polymer compound containing at least one or more of a polyorganosiloxane chain and a polyoxyalkylene chain, a sulfide-based solid electrolyte, and an oxide-based solid electrolyte can be used.

For the positive electrode of the all-solid-state lithium ion secondary battery, for example, a positive electrode mixture containing a solid electrolyte in addition to the positive electrode active material, the conductive agent, and the binder can be supported on a positive electrode current collector such as aluminum, nickel, and stainless steel.

The lithium ion secondary battery 1 of the embodiment can operate at a high voltage and can be increased in capacity during discharge because the positive electrode 2 contains the positive electrode active material of the embodiment.

### <Discharge Curve of Charge-Discharge Cycle>

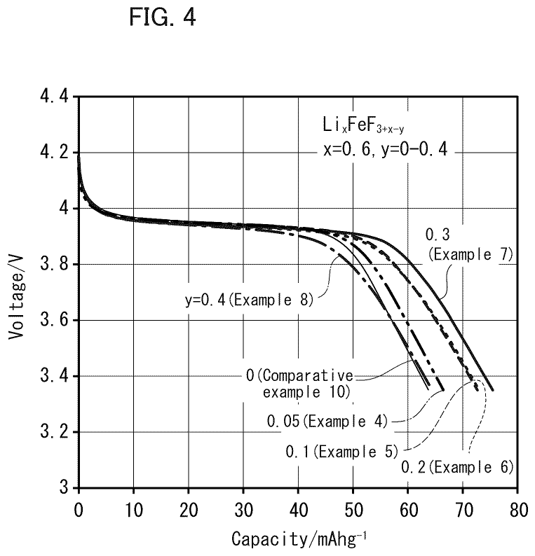

FIG. 4 shows, as an example of the discharge curve in a charge-discharge cycle of the lithium ion secondary battery of the embodiment, a graph where x is x=0.6 and y is 0≤y≤0.4 in the formula (1) (Examples 4 to 8 and Comparative Example 10 described later). The horizontal axis of the graph of FIG. 4 represents the capacity (discharge capacity) of the lithium ion secondary battery. The vertical axis of the graph of FIG. 4 represents the voltage of the lithium ion secondary battery during charge and discharge.

The capacity of the lithium ion secondary battery shown in FIG. 4 is 63.7 mAh/g in Comparative Example 10 (y=0 in the formula (1)), 66.4 mAh/g in Example 4 (y=0.05 in the formula (1)), 72.6 mAh/g in Example 5 (y=0.1 in the formula (1)), 73.0 mAh/g in Example 6 (y=0.2 in the formula (1)), 75.5 mAh/g in Example 7 (y=0.3 in the formula (1)), and 63.8 mAh/g in Example 8 (y=0.4 in the formula (1)), respectively.

As shown in FIG. 4, it can be confirmed that the positive electrode active material in which x is x=0.6 and y is 0≤y≤0.4 in the formula (1) has an increased discharge capacity when y is 0.01<y≤0.4. This is presumably because repulsion between the ferric ion (Fe³⁺) and the lithium ion (Li⁺) is reduced and ion conductivity is improved when y is increased in the positive electrode active material in which x is x=0.6 and y is 0≤y≤0.4 in the formula (1).

<dQ/dV Plot of Charge-Discharge Cycle>

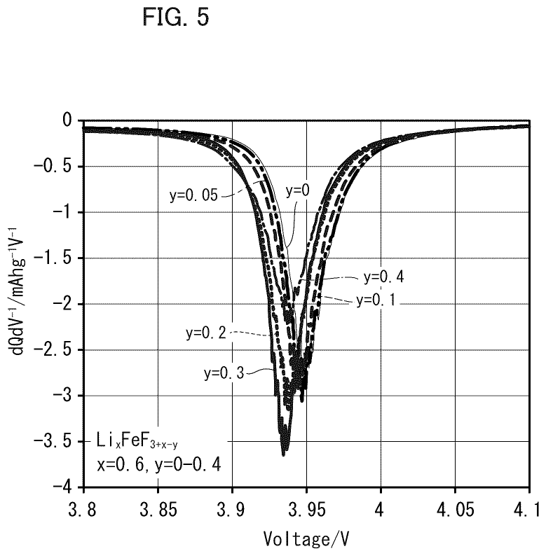

FIG. 5 illustrates the dQ/dV plot in the charge-discharge cycle of FIG. 4. The horizontal axis of the graph in FIG. 5 represents the voltage in the charge-discharge cycle. The vertical axis of the graph in FIG. 5 represents the value obtained by differentiating the capacity of FIG. 4 with the voltage (dQ/dV plot, dQdV⁻¹ plot). The curve convex downward in FIG. 5 represents a curve during discharge.

As illustrated in FIG. 5, the curves during discharge each have a peak at 3.93 to 3.95 V. These peaks indicate that the positive electrode active material undergoes a chemical reaction in the positive electrode during discharge. This indicates that the chemical reaction occurs at a high voltage of 3.93 to 3.95 V during discharge, indicating that the lithium ion secondary battery can operate at a high voltage.

In the lithium ion secondary battery of the embodiment, it is preferable that the dQ/dV plot during discharge in a charge-discharge cycle has a peak in a range of 3.9 to 4.0 V. The fact that the dQ/dV plot during discharge in a charge-discharge cycle has a peak within the above numerical range means that the lithium ion secondary battery can operate at a higher voltage.

In the present specification, the dQ/dV plot “having a peak” means that the dQ/dV plot has a valley having a depth of 0.1 mAhg⁻¹V⁻¹ or more.

In the lithium ion secondary battery of the embodiment, the peak depth of the dQ/dV plot during discharge in a charge-discharge cycle is preferably 0.1 mAhg⁻¹V⁻¹ or more, more preferably 0.5 mAhg⁻¹V⁻¹ or more, still more preferably 1.0 mAhg⁻¹V⁻¹ or more, and particularly preferably 2.0 mAhg⁻¹V⁻¹ or more. When the peak depth of the dQ/dV plot is the lower limit or more, the capacity of the lithium ion secondary battery can be further increased. The maximum value of the peak depth of the dQ/dV plot is not particularly limited, and is preferably, for example, 1000 mAhg⁻¹V⁻¹ or less.

The “peak depth” is given by the depth of the valley (absolute value of the value of the valley bottom) in the dQ/dV plot.

### [Method for Manufacturing Positive Electrode Active Material]

The positive electrode active material of the embodiment contains the above-described lithium-iron composite fluoride as a principal component. As a lithium source of the lithium-iron composite fluoride, it is possible to use a known compound such as a halide such as lithium fluoride (LiF), a hydroxide such as lithium hydroxide monohydrate (LiOH·H₂O), a carbonate such as lithium carbonate (Li₂CO₃), or an acetate such as lithium acetate (CH₃COOLi) or lithium acetate dihydrate (CH₃COOLi·2H₂O), and there is no particular limitation.

As the iron source of the lithium-iron composite fluoride, trivalent iron is preferable rather than divalent iron, and ferric fluoride (FeF₃) is more preferable because high-voltage operation can be performed. In addition, as the iron source of the lithium-iron composite fluoride, ferric fluoride and ferrous fluoride (FeF₂) are preferably used in combination because the capacity during discharge can be further increased.

When the lithium-iron composite fluoride is manufactured, the above-described lithium source and iron source are mixed and subjected to a mechanical processing (first mechanical processing) under predetermined conditions for a predetermined time. For example, when lithium fluoride is used as the lithium source, and divalent iron (FeF₂) and trivalent iron (FeF₃) are used as the iron source, it is considered that the compound represented by the above formula (1) can be formed by the following reaction.

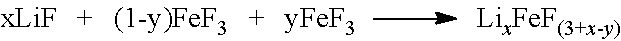

The value of x in the compound represented by the above formula (1) can be adjusted by the molar amount of LiF based on one mole of Fe. The value of y in the compound represented by the above formula (1) can be adjusted by the molar ratio between FeF₃ and FeF₂.

The specific unit applied in the first mechanical processing is not particularly limited, and various units conventionally used for the purpose of pulverizing and mixing a solid substance can be applied. Among these units, a ball mill is preferable, and a planetary ball mill is more preferable because raw materials can be sufficiently pulverized and mixed.

The time for performing the first mechanical processing is preferably, for example, 8 to 12 hours, and more preferably 9 to 11 hours.

As the condition for performing the first mechanical processing, the rotation speed is preferably 250 to 450 rpm, and more preferably 300 to 400 rpm.

The temperature at which the first mechanical processing is performed is not particularly limited, and the mechanical processing can be performed at room temperature (for example, 5 to 30° C.).

The atmosphere for the first mechanical processing is preferably an inert gas (a rare gas such as argon (Ar), a nitrogen (N₂) gas, or the like).

Carbon is added to and mixed with the lithium-iron composite fluoride obtained by the first mechanical processing, and a mechanical processing (second mechanical processing) is performed under predetermined conditions for a predetermined time.

By performing the second mechanical processing, the capacity and rate characteristics of the lithium ion secondary battery can be improved.

Examples of the carbon to be added include a simple substance of carbon such as a carbon nanotube (CNT), carbon black, or graphite, and a carbon fine particle is preferably used. As the carbon fine particle, for example, CNT, carbon black, or the like can be used. Among these carbon fine particles, CNT is preferable from the viewpoint of further improving the electric conductivity of the positive electrode active material.

The conditions for performing the second mechanical processing (unit, time, rotation speed, temperature, atmosphere, and the like) are similar to the conditions for performing the first mechanical processing.

The composite of the lithium-iron composite fluoride and carbon obtained by the second mechanical processing is preferably subjected to a heat treatment. By performing the heat treatment, the crystal structure in the lithium-iron composite fluoride changes, and the capacity of the lithium ion secondary battery using the composite as a positive electrode active material can be increased.

This is presumably because the composition ratio between the crystal structure of Life₂F₆ and the crystal structure of FeF₃ in the lithium-iron composite fluoride changes by the heat treatment, and the crystal structure of LiFe₂F₆ increases.

When the composite of the lithium-iron composite fluoride and carbon is subjected to the heat treatment, the capacity of the lithium ion secondary battery containing the composite as a positive electrode active material can be further increased, and the energy density can be further increased.

The firing temperature in the heat treatment is preferably 100 to 300° C., more preferably 150 to 250° C., and still more preferably 175 to 225° C.

The firing time in the heat treatment is preferably 0.5 to 20 hours, more preferably 2 to 15 hours, and still more preferably 4 to 8 hours.

The atmosphere in the heat treatment is preferably an inert gas (a rare gas such as argon (Ar), a nitrogen (N₂) gas, or the like).

The pressure in the heat treatment may be normal pressure (0.1013 MPa), and is preferably low vacuum (for example, 10² to 10⁵ Pa).

The composite of the lithium-iron composite fluoride and carbon described above may be used as a positive electrode active material, or those obtained by subjecting the composite to the heat treatment (heat-treated composite) may be used as a positive electrode active material.

By preparing a lithium ion secondary battery with the obtained positive electrode active material as a positive electrode, a battery that operates at a high voltage can be obtained.

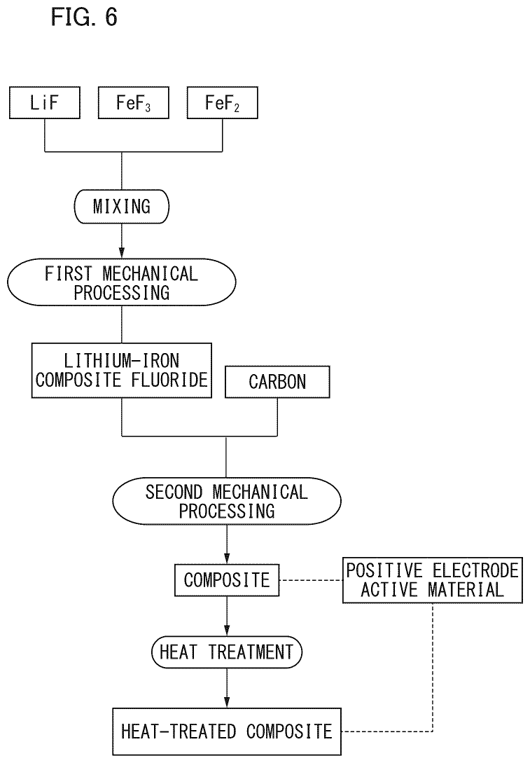

The method for manufacturing a positive electrode active material of the embodiment is shown in a flowchart in FIG. 6.

As shown in FIG. 6, the lithium-iron composite fluoride of the embodiment is preferably represented by the above formula (1), using lithium fluoride, ferrous fluoride, and ferric fluoride as raw materials.

In the formula (1), the molar ratio among Li, Fe, and F is adjusted to be x:1:(3+x-y). At this time, y in the formula (1) is preferably changed depending on the blending amount of the ferrous fluoride.

The meaning of each term in FIG. 6 is the same as the meaning of the term described above.

Hereinafter, Examples of the present invention will be described, but the present invention is not limited to Examples below.

### Example 1

(Preparation of Li_{0.5}FeF_{3.45} (a Compound with x=0.5 And y=0.05 in the Formula (1))

Using a planetary ball mill machine, 0.052 g of lithium fluoride (LiF), 0.429 g of ferric fluoride (FeF₃), and 0.019 g of ferrous fluoride (FeF₂) were subjected to a first mechanical processing. As the planetary ball mill machine, Premium line PL-7 manufactured by Fritsch GmbH was used. The pot and balls were made of zirconium oxide, and 50 g of balls with a diameter of 5 mm was used in a 80 mL pot. The processing conditions of the first mechanical processing were 350 rpm and 10 hours. Thereafter, 0.125 g of carbon nanotube (CNT) was added into the pot, and a second mechanical processing was performed to obtain a composite. The processing conditions of the second mechanical processing were 25° C., 350 rpm, and 10 hours in an Ar atmosphere. The obtained composite was subjected to a heat treatment at 10³ Pa in an argon gas atmosphere at 200° C. by using an oven for five hours to obtain 0.5 g of a positive electrode active material.

### Examples 2 to 12 and Comparative Examples 1 to 24

In the same manner as in Example 1, 0.5 g of a positive electrode active material was obtained, except that LiF, FeF₃, and FeF₂ were weighed so that x and y in the formula (1) were values shown in Tables 1 and 2. In Tables 1 and 2, “y=0” means that no FeF₂ is contained in the raw materials. In Table 1, examples with y=0 are all Comparative Examples, and examples in which the value of discharge capacity is 60.0 mAh/g or more in Table 3 described later and the value of discharge capacity is larger than that of y=0 under the same x value are Examples, and the others are Comparative Examples.

TABLE 1

| | | x | | | | | |
|---|---|---|---|---|---|---|---|
| | | 0.4 | 0.5 | 0.6 | 0.8 | 1.0 | 1.2 |
| y | 0 | Comparative | Comparative | Comparative | Comparative | Comparative | Comparative |
| | | Example 1 | Example 7 | Example 10 | Example 11 | Example 14 | Example 19 |
| | 0.05 | Comparative | Example 1 | Example 4 | Example 9 | Comparative | Comparative |
| | | Example 2 | | | | Example 15 | Example 20 |
| | 0.1 | Comparative | Comparative | Example 5 | Comparative | Example 12 | Comparative |
| | | Example 3 | Example 8 | | Example 12 | | Example 21 |
| | 0.2 | Comparative | Comparative | Example 6 | Example 10 | Comparative | Comparative |
| | | Example 4 | Example 9 | | | Example 16 | Example 22 |
| | 0.3 | Comparative | Example 2 | Example 7 | Example 11 | Comparative | Comparative |
| | | Example 5 | | | | Example 17 | Example 23 |
| | 0.4 | Comparative | Example 3 | Example 8 | Comparative | Comparative | Comparative |
| | | Example 6 | | | Example 13 | Example 18 | Example 24 |

TABLE 2

| | | | x | | | | | |
|---|---|---|---|---|---|---|---|---|
| | | | 0.4 | 0.5 | 0.6 | 0.8 | 1.0 | 1.2 |
| y | 0 | LiF (g) | 0.042 | 0.052 | 0.061 | 0.078 | 0.093 | 0.108 |
| | | FeF₃ (g) | 0.458 | 0.448 | 0.439 | 0.422 | 0.407 | 0.392 |
| | | FeF₂ (g) | 0.000 | 0.000 | 0.000 | 0.000 | 0.000 | 0.000 |
| | 0.05 | LiF (g) | 0.042 | 0.052 | 0.061 | 0.078 | 0.094 | 0.109 |
| | | FeF₃ (g) | 0.438 | 0.429 | 0.421 | 0.404 | 0.389 | 0.375 |
| | | FeF₂ (g) | 0.019 | 0.019 | 0.018 | 0.018 | 0.017 | 0.016 |
| | 0.1 | LiF (g) | 0.043 | 0.052 | 0.062 | 0.079 | 0.095 | 0.110 |
| | | FeF₃ (g) | 0.419 | 0.410 | 0.401 | 0.386 | 0.371 | 0.357 |
| | | FeF₂ (g) | 0.039 | 0.038 | 0.037 | 0.036 | 0.034 | 0.033 |
| | 0.2 | LiF (g) | 0.043 | 0.053 | 0.062 | 0.080 | 0.096 | 0.111 |
| | | FeF₃ (g) | 0.378 | 0.370 | 0.362 | 0.348 | 0.334 | 0.322 |
| | | FeF₂ (g) | 0.079 | 0.077 | 0.075 | 0.072 | 0.070 | 0.070 |
| | 0.3 | LiF (g) | 0.044 | 0.054 | 0.063 | 0.081 | 0.097 | 0.113 |
| | | FeF₃ (g) | 0.336 | 0.329 | 0.322 | 0.309 | 0.297 | 0.286 |
| | | FeF₂ (g) | 0.120 | 0.117 | 0.115 | 0.110 | 0.106 | 0.102 |
| | 0.4 | LiF (g) | 0.044 | 0.055 | 0.064 | 0.082 | 0.099 | 0.114 |
| | | FeF₃ (g) | 0.292 | 0.286 | 0.280 | 0.269 | 0.258 | 0.248 |
| | | FeF₂ (g) | 0.162 | 0.159 | 0.155 | 0.150 | 0.143 | 0.138 |

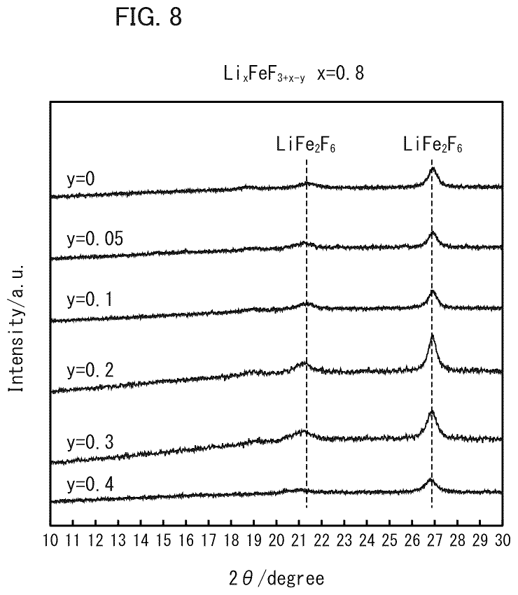

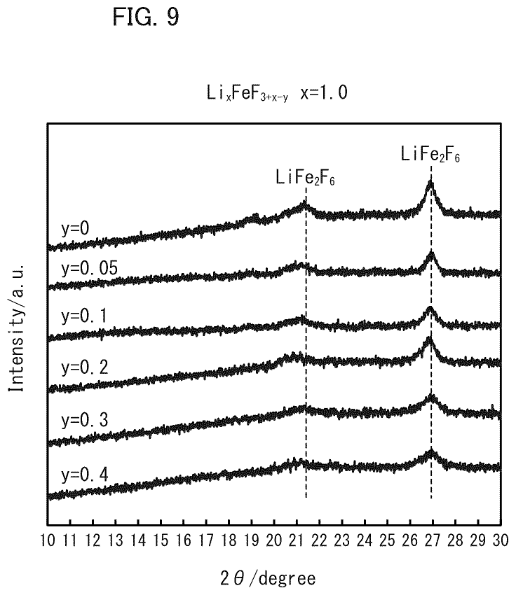

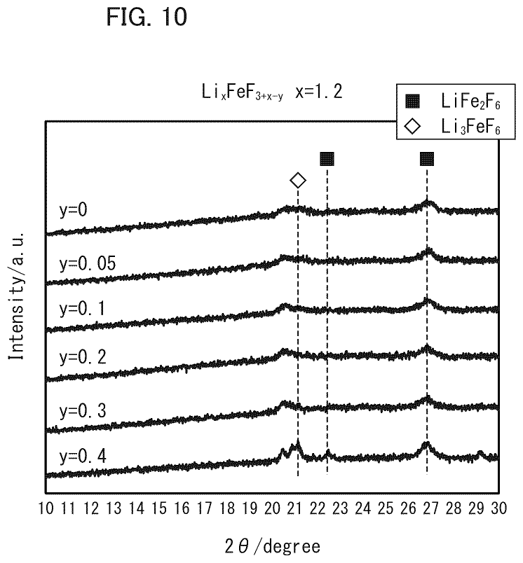

The obtained positive electrode active material in each example was subjected to X-ray diffraction measurement in accordance with the following measurement conditions. The results are shown in FIGS. 1, 2, and 7 to 10.

### <<X-Ray Diffraction Measurement Conditions>>

X-ray diffractometer: SmartLab manufactured by Rigaku Corporation
X-ray source: CuKα radiation (CuKα=1.5418 Å)
Opening angle of incident parallel slit: 5.0°
Length of incident longitudinal limiting slit: 5.0 mm
Opening angle of receiving parallel slit: 5.0°
Kβ filter: Used
Step width: 0.01°
Incident slit: 1/6°
Receiving slit 1: 4.0 mm
Receiving slit 2: 13 mm

As illustrated in FIGS. 1 and 8 to 10, the diffraction pattern of the positive electrode active materials with x=0.6, 0.8, 1.0, and 1.2 in the formula (1) coincided with the diffraction pattern of LiFe₂F₆, which has DB card number 01-074-2193, space group P42/mnm, and a tetragonal crystal system, and it was found that the positive electrode active materials had a crystal structure similar to that of LiFe₂F₆.

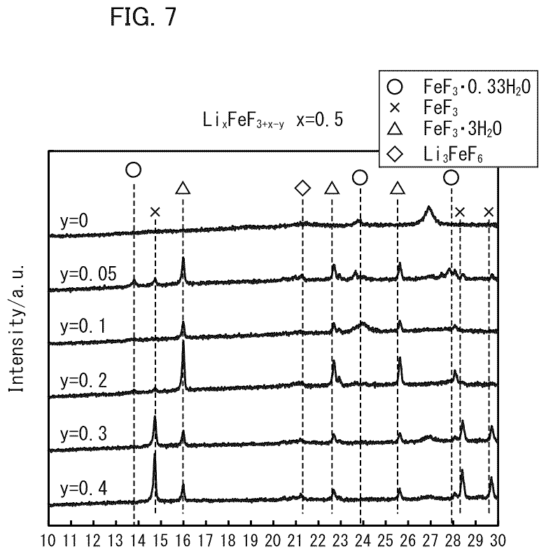

On the other hand, as illustrated in FIGS. 2 and 7, it was found that the positive electrode active materials with x=0.4 and 0.5 in the formula (1) had peaks derived from the crystal structures of FeF₃·0.33H₂O and FeF₃·3H₂O, in addition to the diffraction pattern of FeF₃, which has DB card number 00-061-0194, space group R-3c, and a trigonal crystal system. This is presumably because the positive electrode active materials with x=0.4 and 0.5 in the formula (1) have poor water resistance, and are easily attached with moisture.

### [Production of Lithium Ion Secondary Battery]

### (Preparation of Positive Electrode)

By dispersing 80 parts by mass of the positive electrode active material obtained in each of Examples 1 to 12 and Comparative Examples 1 to 24, 10 parts by mass of acetylene black, and 10 parts by mass of polyvinylidene fluoride in N-methylpyrrolidone as a solvent, a slurry (positive electrode mixture) including, as solid contents, 80% by mass of the positive electrode active material, 10% by mass of acetylene black, and 10% by mass of polyvinylidene fluoride was prepared. This slurry was applied onto an aluminum foil, pressed at 15 tons, and then punched with a puncher having a diameter of 10 mm to prepare a positive electrode. At this time, the mass of the positive electrode active material was adjusted to 3.5 mg.

### (Preparation of Coin-Type Cell)

The prepared positive electrode (diameter: 10 mm) was placed on a positive electrode can, a porous polyethylene film serving as a separator was placed thereon, and the resulting product was pressed with a polypropylene gasket. Thereafter, a Li negative electrode having a thickness of 0.5 mm was placed thereon, and a spacer for thickness adjustment was placed thereon. Thereafter, as a non-aqueous electrolytic solution, a mixed solvent of ethylene carbonate and diethyl carbonate (volume ratio: 5:5) in which 1 mol/L lithium hexafluorophosphate was dissolved was added between the positive electrode can and the negative electrode, the separator was impregnated with the mixed solvent, and a negative electrode can was placed thereon and sealed to prepare a coin-type cell (lithium ion secondary battery).

### [Evaluation of Battery Performance]

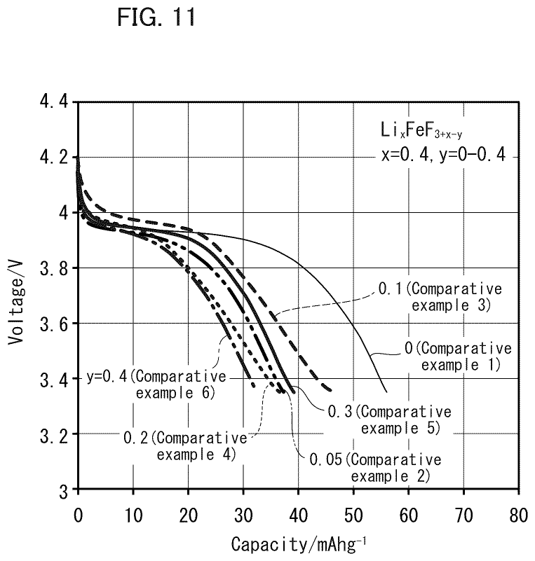

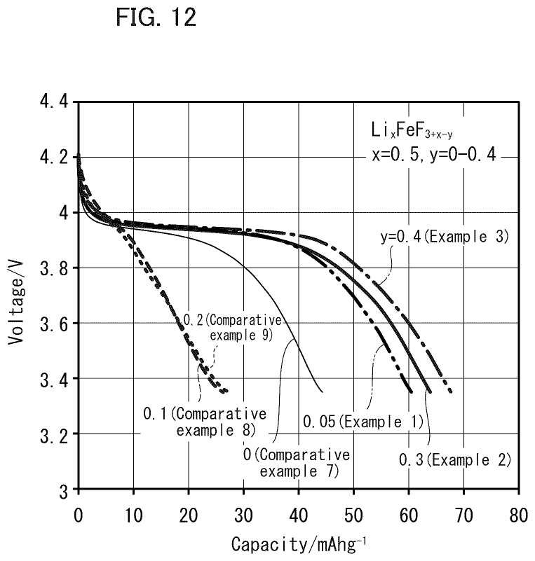

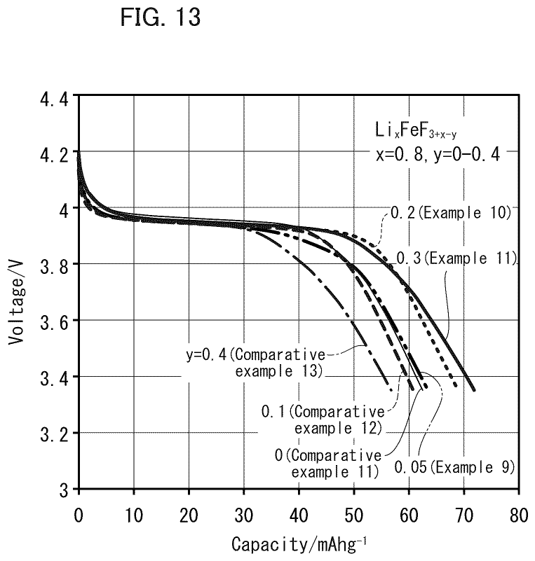

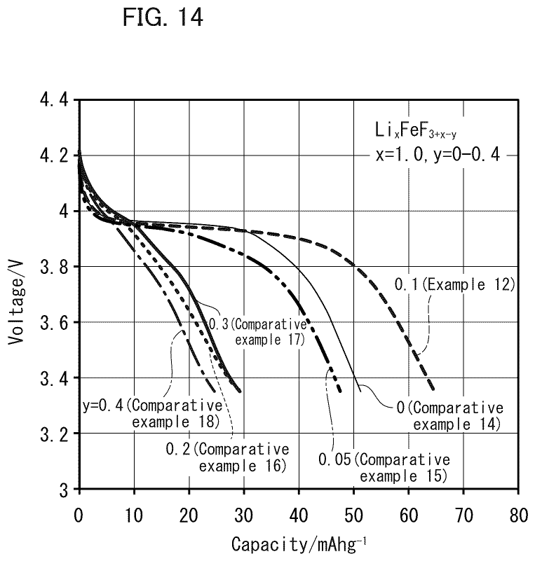

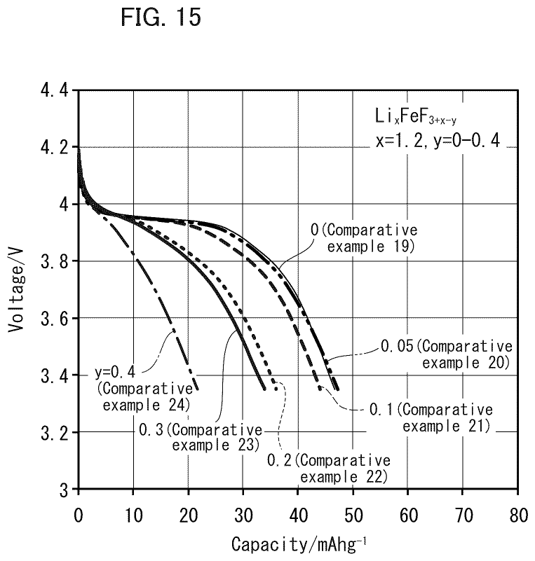

The battery performance of the prepared coin-type cell was evaluated. Specifically, the prepared coin-type cell was charged and discharged at a constant current having a current value of 5 mA/g (0.025 C: 1C=200 mA/g) per mass of the positive electrode active material. During charge and discharge at a constant current, the upper limit voltage was 4.25 V, and the lower limit voltage was 3.35 V. The resting time after charge and discharge was 10 minutes. The discharge capacity (mAh/g) was calculated per unit mass of the positive electrode active material. The discharge curve of each example during charge and discharge at a constant current is illustrated in FIGS. 4 and 11 to 15.

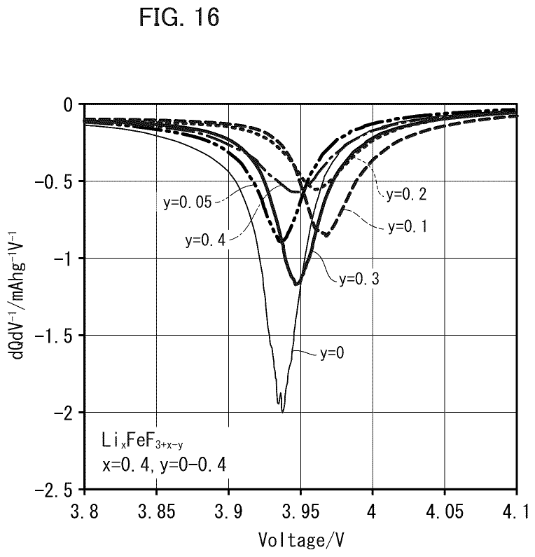

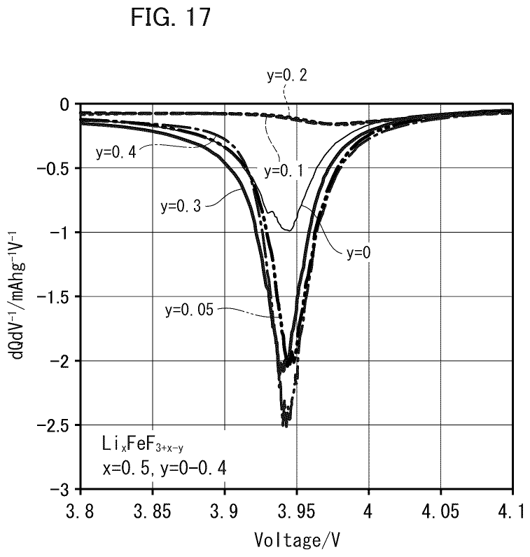

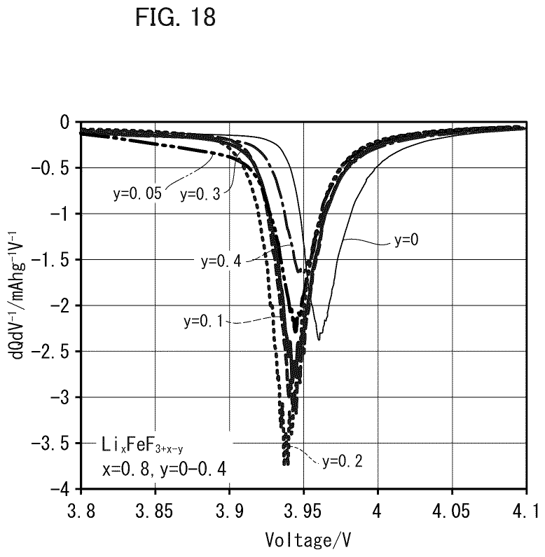

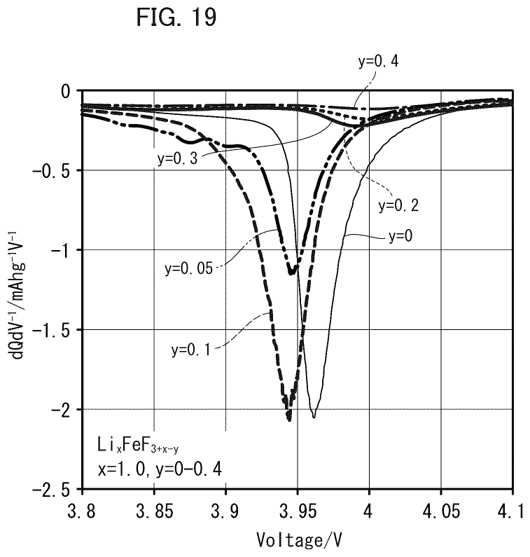

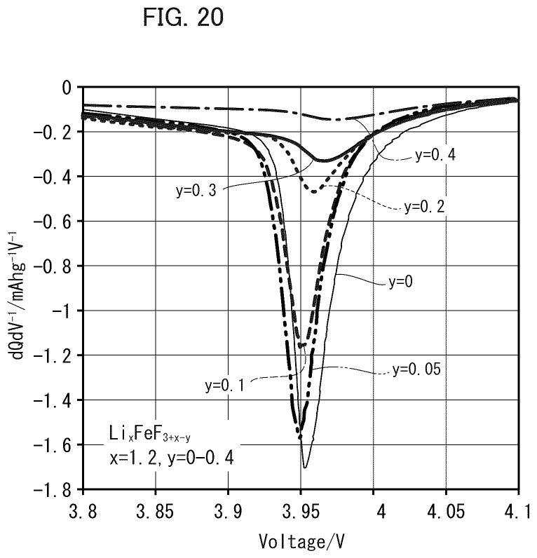

From each of the obtained discharge curves, a dQ/dV plot was created with the horizontal axis representing the voltage and the vertical axis representing the value obtained by differentiating the capacity with the voltage (dQ/dV, dQdV⁻¹), and the voltage at which a chemical reaction occurred (reaction voltage) was determined from the peak voltage of the dQ/dV plot during discharge. The dQ/dV plot in each example is illustrated in FIGS. 5 and 16 to 20.

As illustrated in FIGS. 5 and 16 to 20, in each of Examples 1 to 12 to which the present invention was applied, the peak voltage of the dQ/dV plot during discharge was as high as 3.9 to 4.0 V, and it was confirmed that the chemical reaction occurred at a high voltage inherent to the compound represented by the formula (1).

On the other hand, in Comparative Examples 1 to 24, in which x and y in the formula (1) were out of the scope of the present invention, as illustrated in FIGS. 5 and 16 to 20, the peak depth at the peak voltage of the dQ/dV plot during discharge observed around 4 V was shallower than those in Examples 1 to 12.

Table 3 summarizes the values of discharge capacity during discharge in the above results. In Table 3, the unit of the numerical value is “mAh/g”.

TABLE 3

| | | x | | | | | |
|---|---|---|---|---|---|---|---|
| | | 0.4 | 0.5 | 0.6 | 0.8 | 1.0 | 1.2 |
| y | 0 | 56.0 | 44.2 | 63.7 | 62.5 | 51.3 | 46.5 |
| | 0.05 | 37.4 | 60.4 | 66.4 | 63.3 | 47.6 | 47.1 |
| | 0.1 | 46.4 | 26.3 | 72.6 | 60.8 | 64.7 | 44.0 |
| | 0.2 | 36.4 | 27.3 | 73.0 | 68.9 | 29.6 | 36.0 |
| | 0.3 | 39.1 | 63.9 | 75.5 | 71.9 | 29.6 | 33.8 |
| | 0.4 | 32.5 | 67.6 | 63.8 | 56.8 | 24.6 | 21.6 |

Table 4 summarizes the values of peak voltage during discharge in the above results. In Table 4, the unit of the numerical value is “V”.

TABLE 4

| | | x | | | | | |
|---|---|---|---|---|---|---|---|
| | | 0.4 | 0.5 | 0.6 | 0.8 | 1.0 | 1.2 |
| y | 0 | 3.93 | 3.94 | 3.95 | 3.96 | 3.96 | 3.95 |
| | 0.05 | 3.93 | 3.94 | 3.95 | 3.95 | 3.95 | 3.95 |
| | 0.1 | 3.97 | 3.97 | 3.94 | 3.95 | 3.94 | 3.95 |
| | 0.2 | 3.96 | 3.97 | 3.93 | 3.94 | 4.00 | 3.96 |
| | 0.3 | 3.95 | 3.94 | 3.93 | 3.95 | 3.99 | 3.96 |
| | 0.4 | 3.95 | 3.94 | 3.94 | 3.95 | 4.00 | 3.97 |

The above results revealed that, according to the present invention, it is possible to provide an Fe-based positive electrode active material that can operate at a high voltage and can be increased in capacity during discharge, and a lithium ion secondary battery including the positive electrode active material.

What is claimed is:

1. A positive electrode active material comprising a lithium-iron composite fluoride as a principal component,
the lithium-iron composite fluoride being represented by the following formula (1), 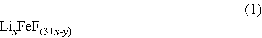
where, x and y are numbers satisfying 0.4<x<1.2 and 0.01<y<0.5.

2. The positive electrode active material according to claim 1, wherein, in the formula (1), x and y are numbers satisfying:
$$0.4 < x \leq 0.5 , and 0.01 < y < 0.1 or 0.2 < y < 0.5 ;$$
$$0.5 < x \leq 0.7 , and 0.01 < y < 0.5 ;$$
$$0.7 < x < 1. , and 0.01 < y < 0.1 or 0.1 < y < 0.4 ; or$$
$$1. \leq x < 1.2 , and 0.05 < y < 0.2 .$$

3. The positive electrode active material according to claim 2, having a peak in a range of 20°≤20≤30° in an X-ray diffraction pattern.

4. A lithium ion secondary battery comprising: a positive electrode; a negative electrode; and an electrolyte, wherein the positive electrode contains the positive electrode active material according to claim 1.

5. The lithium ion secondary battery according to claim 4, wherein a dQ/dV plot during discharge in a charge-discharge cycle has a peak in a range of 3.9 to 4.0 V.

6. The lithium ion secondary battery according to claim 4, having an average discharge voltage of 3.8 to 4.0 V.

7. A method for manufacturing a positive electrode active material containing a lithium-iron composite fluoride as a principal component, the method comprising: using lithium fluoride, ferrous fluoride, and ferric fluoride as raw materials,
wherein the lithium-iron composite fluoride is represented by the following formula (1), 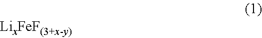
where, x and y are numbers satisfying:
$$0.4 < x \leq 0.5 , and 0.01 < y < 0.1 or 0.2 < y < 0.5 ;$$
$$0.5 < x \leq 0.7 , and 0.01 < y < 0.5 ;$$
$$0.7 < x < 1. , and 0.01 < y < 0.1 or 0.1 < y < 0.4 ; or$$
$$1. \leq x < 1.2 , and 0.05 < y < 0.2 .$$

8. The method for manufacturing a positive electrode active material according to claim 7, wherein y in the formula (1) is changed depending on a blending amount of the ferrous fluoride.
